(19) United States
(12) Patent Application Publication
(10) Pub. No.: US 2006/0207083 A1
(43) Pub. Date: Sep. 21, 2006

(54) Adjusting method and device for magnetic head position

(75) Inventors: Ko Shinomori, Ehime (JP); Masayoshi Matsumoto, Ehime (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/372,096

(22) Filed: Mar. 10, 2006

(30) Foreign Application Priority Data
Mar. 10, 2005 (JP) 2005-066425

(51) Int. Cl. G11B 5/187

(52) U.S. Cl. 29/603.12; 360/122; 29/603.01; 29/603.09; 29/603.07

(57) ABSTRACT

The present invention provides a method of easily adjusting relative positions of a magnetic head gap and guide rollers of a magnetic tape recording/reproducing device without using an adjust reference tape and a device of the same. Relative position of guide rollers (9) and a magnetic head gap (11) is adjusted independently to a device reference plane defined on the magnetic tape recording/reproducing device (7).

### TECHNICAL FIELD

The invention relates to an adjusting method and device of magnetic head position, and more particularly to a technology of adjusting the relative position and inclination of magnetic head gap and guide roller easily and at high precision, as one of most important elements for assuring favorable recording and reproducing performance in assembling of magnetic tape recording/reproducing device.

### BACKGROUND ART

In a magnetic tape recording/reproducing device, to assure favorable recording and reproducing performance on magnetic tape, the tape surface and magnetic head gap must completely contact with each other flatly by a proper pressing force. Accordingly, tape running system parts consisting of magnetic head block, peripheral tape reel and guide roll must be present at appropriate relative positions.

The configuration of these tape running system parts is explained by referring to a schematic diagram of general magnetic tape recording/reproducing device shown in FIG. 3A. In FIG. 3A, in the magnetic tape recording/reproducing device, three reference points are defined as the standard for assembling operation on the bottom of the device, and the surface including these three reference points is the assembling reference surface.

At reference points 1 and 2 of the bottom of the device, reference holes are provided for defining the two-dimensional coordinates of the reference coordinates on the assembling reference plane.

A reel motor 8, a guide roller 9, and a magnetic head gap 11 shown in FIG. 3A must be assembled at adequate positions relating to position adjusting elements (axes) along center of three mutually orthogonal axes x, y, z, and six adjusting elements (axes) with inclination adjusting elements (axes) of azimuth, zenith and roll of rotational direction components around center of three axes, with respect to the assembling reference plane and reference coordinates. The adjusting elements are described in the drawing as the representative of magnetic head block 10.

Hitherto, the relative position adjustment of these running system parts has been assured by the assembling tolerance to the device reference on the basis of processing precision of all component parts, except for the portions relating to the height of the guide roll 9, that is, in the z-axis direction, and generally only the adjustment of azimuth of magnetic head block of highest demanded precision has been executed by adjusting the height of the guide roller 9 while reproducing by the magnetic head by installing the tape reel 22 winding a reference tape 21 for adjustment recording reference signals in a magnetic tape recording/reproducing device as shown in FIG. 3B.

For example, patent document 1 (Japanese Patent Application Laid-Open No. 5-6511) discloses a head mounting and positioning adjusting device for mounting and positioning mutual magnetic heads of composite type magnetic heads, and it comprises tape driving means for sliding the magnetic head simultaneously on the magnetic head for recording and magnetic head for reproducing, reference signal generating means for generating a reference signal, signal output measuring means for measuring recording signal output of the magnetic head for recording and reproducing signal output of the magnetic head for reproducing, and parallelism adjusting means for adjusting the parallelism of mutual gap of magnetic head for recording and magnetic head for reproducing by the output of the signal output measuring means.

Other conventional adjusting method is disclosed, for example, in FIG. 4. In FIG. 4, an adjusting jig 23 includes a base plate 16, a fixing pin 17 for receiving a reference point of magnetic tape recording/reproducing device 7, a laser length measuring device 18, and uniaxial moving means 19 for moving the laser length measuring device 18 vertically to the base plate 16.

First, a master work relatively positioned between device reference plane and magnetic head gap by predetermined precision is fixed on the adjusting jig 23, and the distances to the slider surface of the magnetic head position are measured from measuring position 1 and measuring position 2 remote by distance d, and M1 and M2 are obtained.

The magnetic tape recording/reproducing device 7 for adjustment is placed in the measuring jig 23, and distances at two positions of measuring position 1 and measuring position 2 are measured in the same procedure as when measuring the master work, and W1 and W2 are obtained.

From these values, supposing the zenith component of master work to be Zm, the zenith component Zw of the magnetic tape recording/reproducing device 7 for adjustment can be determined in the formula below.
Zw=Zm+tan⁻¹((M1−W1)−(M2−W2)/d (degrees)

Further, adjustment and measurement of inclination of magnetic head block are repeated until the value of Zw becomes less than specified value.

### DISCLOSURE OF THE INVENTION

### Problems to be Solved by the Invention

However, by increase of tape running speed due to recent enhancement in magnetic tape recording density and recording and reproducing speed, the head pressing force of tape is increased, and the running inertia of tape itself is increased, and it is becoming difficult to adjust and manage the two elements of azimuth and zenith out of the six adjusting elements (axes) mentioned above only by adjusting the conventional parts assembling tolerance and adjusting the running path by guide roller.

More specifically, in azimuth adjustment, if the guide roller height is changed by increasing the tape running speed and running inertia, the tape running path does not follow the change, and the tape may ride over the flange of roller, or crease may be formed at tape edge in a worst case.

In zenith adjustment, a more tight contact state of tape and magnetic head slider surface is demanded, and the recording and reproducing performance cannot be assured by the conventional parts assembling tolerance.

The invention is devised in the light of the above problems, and it is hence an object thereof to present a method of adjusting the magnetic head gap assembled in the slider surface of magnetic head block and the relative position and inclination of guide rollers disposed at both sides thereof, easily and precisely without using reference tape for adjustment, and an device for realizing this method.

### Means for Solving the Problems

To solve the problems, the magnetic head position adjusting method in one aspect of the invention is a method relating to a magnetic tape recording/reproducing device, for adjusting the magnetic head gap assembled in the slider surface of magnetic head block, and the relative position and inclination of two guide rollers disposed at a proper distance each at both sides of the magnetic head block, comprising a magnetic head gap adjusting step of adjusting the relative position and inclination of magnetic head gap with respect to the device reference plane defined on the magnetic tape recording/reproducing device, and a guide roller adjusting step of adjusting the position and inclination of two guide rollers with respect to the device reference plane.

In this constitution, the relative positions of magnetic head gap and guide rollers are independently assured with respect to the device reference plane, and hence the relative positions of magnetic head gap and guide rollers are assured. Therefore, it is not required to adjust while running and reproducing the conventional reference tape for adjustment, and moreover various adjustment problems occurring due to enhancement of performance of device can be avoided.

In the magnetic head position adjusting method in other aspect of the invention, the magnetic head gap adjusting step is to adjust the relative position and inclination of magnetic head gap with respect to the device reference plane defined on the magnetic tape recording/reproducing device, about six adjusting elements of position adjusting elements along each axial center of three mutually orthogonal axes and inclination adjusting elements along the rotating direction around each axial center, and includes a first adjusting step of adjusting the adjusting elements lower in required adjustment precision, and a second adjusting step of adjusting the adjusting elements higher in required adjustment precision after the first adjusting step.

In this constitution, supposing the three mutually orthogonal axes of six adjusting elements to be x, y, z, and the rotating direction components around each axial center of three axes to be azimuth, zenith and roll, in a general magnetic tape recording/reproducing device, among six adjusting elements of magnetic head block, as compared with the adjusting elements of azimuth and zenith, the required adjustment precision is lower in other four adjusting elements, that is, x, y, z, and roll.

Therefore, in relative position adjustment of magnetic head gap with respect to the device reference plane, first, by repeating the first adjusting step of adjusting the four adjusting elements of x, y, z, and roll, and the second adjusting step of adjusting the azimuth and zenith successively, occurrence of re-adjustment often occurring in multi-axis position adjustment can be suppressed to a minimum, thereby settling to required precision earlier, and the time required for adjustment can be shortened substantially.

The magnetic head position adjusting device in a different embodiment of the invention is an adjusting device for adjusting the relative position and inclination of magnetic head gap with respect to the device reference plane defined on the magnetic tape recording/reproducing device, comprising a first reference plane defined on the adjusting device, a second reference plane fixed by the relative position relation predetermined on the first reference plane, holding and fixing means for holding the magnetic tape recording/reproducing device disposed on the first reference plane and fixing the device reference plane of the magnetic tape recording/reproducing device, and an optical microscope fixed on the second reference plane.

By using the device having such structure, the relative height and inclination of magnetic head gap with respect to the reference plane defined on the magnetic tape recording/reproducing device can be adjusted easily.

The magnetic head position adjusting method in a further aspect of the invention makes use of an adjusting device of magnetic head position, and is characterized by adjusting the relative position and inclination of magnetic head gap with respect to the device reference plane defined on the magnetic tape recording/reproducing device, on the basis of focusing information of all viewing field of magnified image by optical microscope.

In this constitution, the zenith component can be visually recognized on the basis of the image of the fixed microscope, and the adjusting work is easy, and the time required for adjusting work can be shortened substantially.

### Effects of the Invention

According to the invention, the magnetic head gap assembled in the slider surface of magnetic head block, and relative position and inclination of two guide rollers disposed at a proper distance each at both sides of the magnetic head block can be adjusted easily and precisely without using reference tape for adjustment.

### BRIEF DESCRIPTION OF THE DRAWINGS

FIG. 1 is a perspective view of magnetic head position adjusting device in a first embodiment of the invention.

FIGS. 2A, 2B, 2C, 2D are explanatory diagrams of magnetic head gap adjusting process in the same embodiment.

FIGS. 3A, 3B are explanatory diagrams of position adjustment of magnetic head gap in a magnetic tape recording/reproducing device.

FIG. 4 is an explanatory diagram of conventional zenith component adjustment in magnetic tape recording/reproducing device.

FIG. 5 is a model diagram showing an example of structure of two-half camera.

FIG. 6 is a perspective view of magnetic head position adjusting device in a second embodiment of the invention.

### BEST MODE FOR CARRYING OUT THE INVENTION

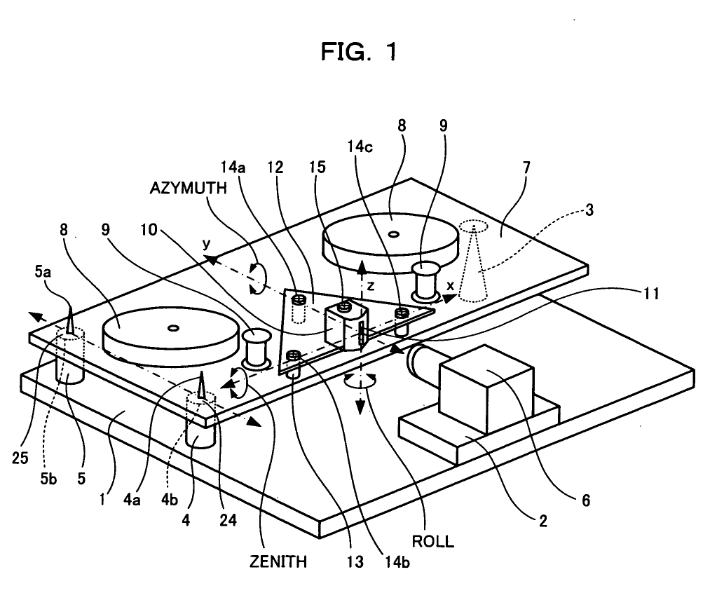

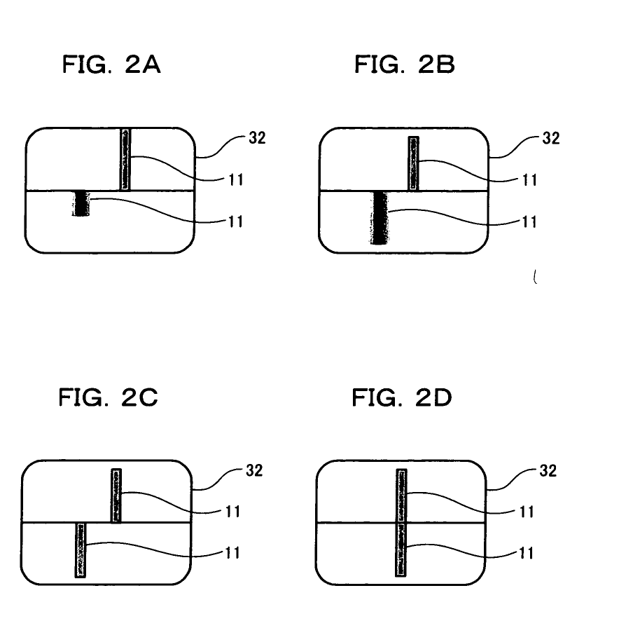

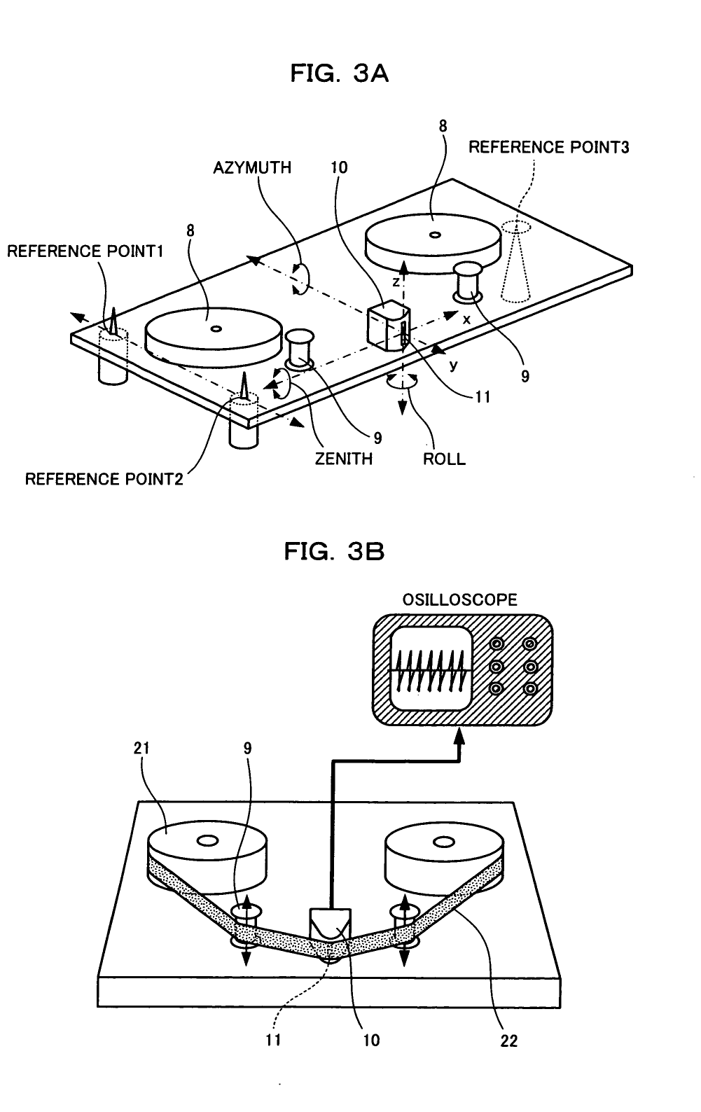

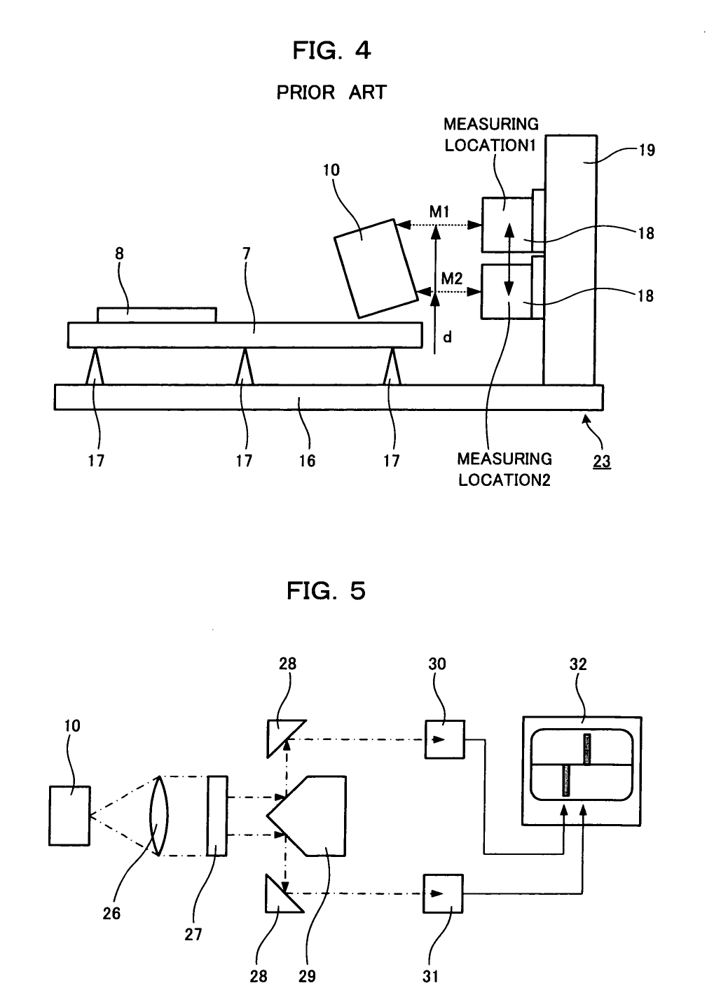

A preferred embodiment of the invention is described below while referring to accompanying drawings. FIG. 1 is a perspective view of magnetic head position adjusting device in a first embodiment of the invention. FIG. 2 shows explanatory diagrams of adjusting process in the magnetic head position adjusting method.

In FIG. 1, the magnetic head position adjusting device includes a first reference plane defined on the adjusting device, and a second reference plane fixed in relative position relation predetermined on the first reference plane 1.

Pins 3, 4, 5 provided on the first reference plane 1 are holding and fixing means for holding a magnetic tape recording/reproducing device 7, and fixing the device reference plane of the magnetic tape recording/reproducing device 7, and are fixed on the first reference plane 1 by mutually positioning so as to coincide with the configuration of definition points of reference plane defined on the lower side of the magnetic tape recording/reproducing device 7.

The pins 4 and 5 are processed in steps with tapers, and tapers 4a and 5a are fitted into positioning holes 24 and 25 processed on the magnetic tape recording/reproducing device, and by steps 4b and 5b of pins 4 and 5 and the pin 3, two-dimensional coordinates on the device reference plane of the magnetic tape recording/reproducing device 6 are defined.

On the second reference plane 2, an optical microscope 6 is fixed. In this embodiment, a two-half camera of prior art is used as the optical microscope, and its structure is described later.

The magnetic tape recording/reproducing device 7 includes a reel motor 8, a guide roller 9, and a magnetic head block 10, and the magnetic head block 10 has a magnetic head gap 11 assembled in slider surface.

The magnetic head block 10 is disposed on an adjusting mechanism composed of a magnetic head block mounting plate 12, adjusting screws 14a, 14b, 14c, and a damper 13, and is fixed on the magnetic head block mounting plate 12 by means of magnetic head block fixing screw 15. The adjusting elements to be adjusted by this adjusting mechanism are zenith, azimuth, and z components, and these adjusting elements are described below.

The adjusting screws 14a, 14b, 14c are fitted to the chassis of magnetic tape recording/reproducing device 7 having screw holes by way of holes driven in the magnetic head block mounting plate 12 and the hollow damper 13, and the position can be adjusted within an elastic range of the damper 13.

The fixing screw diameter provided in the magnetic head block 10 is slightly larger than the diameter of magnetic head block fixing screw 15, and the magnetic head block 10 can be adjusted in the position of x, y and roll components on the magnetic head block mounting plate 12.

The two-half camera is composed as shown in FIG. 5, and takes images by two CCD cameras 30, 31 by way of objective lens 26, collimator lens 27, and total reflection mirrors 28, 29, and displays on a two-half monitor 32.

By the optical microscope 6 having the two-half camera, the magnetic head gap 11 of the magnetic head block 10 is taken, and magnified images at both ends of the magnetic head gap 11 are displayed on one screen in the two-half monitor 32. In the optical microscope 6 having the two-half camera, by using the objective lens 26 of high magnification and shallow focus depth, inclination information of magnetic head gap 11 can be more clearly obtained by the focusing information obtained from the two-half monitor 32.

The magnetic tape recording/reproducing device 7 is designed to adjust the relative position and inclination of magnetic head gap 11 with respect to the device reference plane, about six adjusting elements of position adjusting elements along each axial center of three mutually orthogonal axes and inclination adjusting elements along the rotating direction around each axial center, and in the embodiment, supposing the three mutually orthogonal axes to be x, y, z, and the rotating direction components around each axial center of three axes to be azimuth, zenith and roll, six adjusting elements are described below.

Herein, the z-axis is an axis of coordinates in vertical direction in three-dimensional spatial coordinates, the x-axis is orthogonal to the z-axis, and is the axis of coordinates orthogonal to the optical axis of the optical microscope 6, the y-axis is orthogonal to the z-axis and x-axis, and is the axis of coordinates orthogonal to the optical axis of the optical microscope 6, the azimuth is rotating direction component around axial center of the y-axis, the zenith is rotating direction component around axial center of the x-axis, and the roll is rotating direction component around axial center of the z-axis.

Using the magnetic head position adjusting device having such structure, the adjusting method of relative positions of magnetic head gap and guide rollers is explained below.

First, in the guide roller adjusting process, the relative position of guide roller 9 is adjusted on the device reference plane of the magnetic tape recording/reproducing device 7. This adjustment is realized by known art, using various position measuring instruments such as three-dimensional measuring instrument, automatic collimator, and laser length measuring device. It may be also realized by the technology previously disclosed by the present applicant (Japanese Patent Application Laid-Open No. 2003-420241) as described below.

A measuring instrument for measuring the height difference between planes and inclination angle is used, and this measuring instrument is intended to measure the height difference of measuring plane to comparative reference plane and the inclination angle, assuming one plane as comparative reference plane and other arbitrary plane as measuring plane, in the object of measurement having plural relatively immobile planes, comprising surface plate means having a surface plate as inspection reference, measuring object holding means for holding the measuring object in contact with the surface plate of the surface plate means on the comparative reference plane, and measuring means for measuring the distance to the measuring plane of the measuring object in a direction parallel to the perpendicular direction of surface plate of surface plate means at plural measuring points.

In measurement, preliminarily, as initial value of measuring means, the distance to the surface plate of surface plate means is measured. For this purpose, a master work (reference device) is pressed to the surface plate of surface plate means on the reference plane, and held by the measuring object holding means, and the distance to the reference plane is measured by the measuring means supposing the reference plane of the master work opposite to the measuring means to be equivalent to the surface plate. In a standard master work, the reference plane is a single plane.

In this measurement, the measuring object is fitted to the surface plate of surface plate means on comparative reference plane, and is held by the measuring object holding means, and the distance to the measuring plane of the measuring object opposite to the measuring means is measured, and the difference of the measured distance and the initial value is obtained as the measured value.

More specifically, a virtual plane parallel to surface plate is assumed and overlapped on the reference plane of master work and the measuring plane of measuring object, the X-axis and Y-axis orthogonal to the virtual plane are set, and assuming the intersection of X-axis and Y-axis to be reference point, first measuring point on Y-axis, second measuring point on intersection of X-axis and Y-axis, and third measuring point on X-axis existing at a specified distance apart on X-axis and Y-axis are set, and distance of first measuring point and second measuring point and distance of second measuring point and third measuring point are obtained as known specified values.

When measuring the initial value, the length is measured at first measuring point on Y-axis, second measuring point on intersection of X-axis and Y-axis, and third measuring point on X-axis, projected on the reference plane of master work opposite to the measuring means.

Measured values at measuring points are supposed to be initial value of first measuring point on Y-axis, initial value of second measuring point on intersection of X-axis and Y-axis, and initial value of third measuring point on X-axis.

When measuring, the measuring object is fitted to the surface plate of surface plate means on comparative reference plane, and is held by the measuring object holding means, and the distance to the measuring plane of the measuring object opposite to the measuring means is measured at the same measuring point on the master work.

The difference of the measured distance at each measuring point and the initial value is obtained as the measured value at each measuring point, and the measured value at first measuring point, measured value at second measuring point, and measured value at third measuring point are calculated.

Of the calculated measured values, the measured value at second measuring point as reference point is obtained as height difference (penetration) of comparative reference plane and measuring plane of measuring object.

Next, inclination angle of measuring plane to comparative reference plane of the measuring object is calculated. Inclination angle about X-axis (pitch) is calculated by inverse trigonometric function from the relation of distance of first measuring point and second measuring point as known specified value, and differential value of measured value at second measuring point as reference point and measured value at first measuring point. Inclination angle about Y-axis (roll) is calculated by inverse trigonometric function from the relation of distance of second measuring point and third measuring point as known specified value, and differential value of measured value at second measuring point as reference point and measured value at third measuring point.

In the subsequent magnetic head gap adjusting process, the relative position of magnetic head gap 11 of tape contact surface of magnetic head block 10 opposite to the device reference plane of the magnetic tape recording/reproducing device 7 is adjusted.

First, the master work of which position of magnetic head gap 11 assembled in the slider surface of the magnetic head block 10 may be within a certain standard on the apparatus reference plane of the magnetic tape recording/reproducing apparatus 7 is set on the magnetic head position adjusting apparatus. The position of optical microscope 6 is calibrated so that the magnified image of magnetic head gap 11 by the optical microscope 6 may be in the state shown in FIG. 2D, and it is completely fixed in this state. Operation of position calibration by position adjusting mechanism (not shown) of optical microscope 6 is a general operation and its explanation is omitted.

Consequently, the magnetic tape recording/reproducing apparatus 7 for adjusting is installed in the magnetic head position adjusting apparatus after completion of calibration, the magnetic head block fixing screw 15 is loosened, and while monitoring the image of two-half monitor 32 of the optical microscope 6, a first adjusting step is executed for adjusting the adjusting elements lower in required adjustment precision, and a second adjusting step is executed for adjusting the adjusting elements higher in required adjustment precision after the first adjusting step.

At the first adjusting step, four adjusting elements lower in required adjustment precision are adjusted, that is, x, y, z, and roll.

First, both ends of magnetic head gap 11 are brought into the viewing field of optical microscope 6, and roughly adjusted to settle within the screen of the two-half monitor 32. FIG. 2A shows the monitor screen at this time.

Then, as shown in FIG. 2B, while both ends of magnetic head gap 11 are captured within the viewing field of optical microscope 6, the gap image of one of two ends of magnetic head gap 11 is focused by y component adjustment.

At the second adjusting step, using the adjusting screw 14a, the zenith component of higher required adjustment precision is adjusted. At this time, if the focusing state of magnetic head gap 11 is changed by adjustment of zenith component, y direction component is adjusted at the same time, and the gap images at both ends of magnetic head gap 11 is focused as shown in FIG. 2C.

Using both adjusting screws 14b and 14c, the azimuth component of higher required adjustment precision is adjusted, and the same image as master work is obtained as shown in FIG. 2D, and all adjustment process is completed.

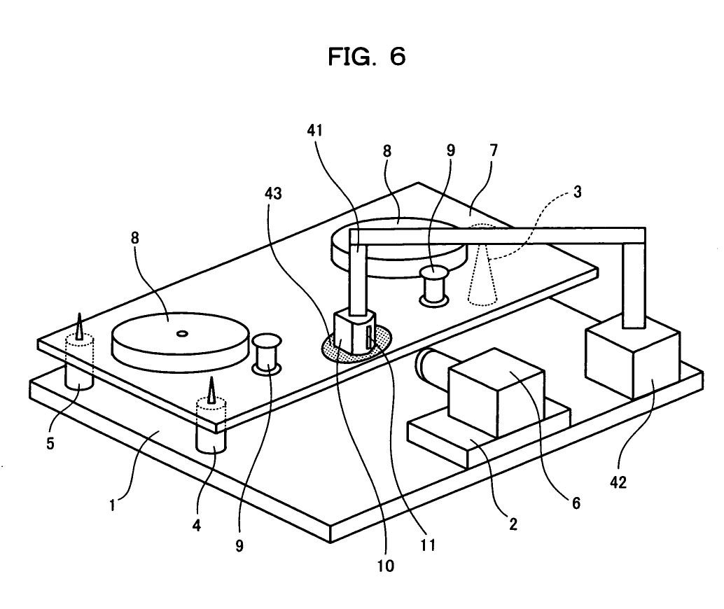

In the embodiment, for adjustment and fixing of position of magnetic head gap 11 with respect to the device reference plane, the adjusting mechanism of the magnetic tape recording/reproducing device is used, but in a second embodiment, the adjusting mechanism may include, in addition to the main body of magnetic head position adjusting device, magnetic head block holding means 41 composed of robot arm and others, and six-axis driving means 42 capable of driving in the directions of six adjusting elements as shown in FIG. 6.

Using the magnetic head block holding means 41 and six-axis driving means 42, the magnetic head block 10 and magnetic head gap 11 are adjusted about six adjusting elements, and the magnetic head block 10 can be fixed on the magnetic tape recording/reproducing device 7 by an adhesive 43.

### INDUSTRIAL APPLICABILITY

According to the invention, the magnetic head gap assembled in the slider surface of magnetic head block, and the relative position and inclination of two guide rollers disposed at a proper distance each at both sides of the magnetic head block can be adjusted easily and precisely without using reference tape for adjustment, so that it is ideal for assembling of magnetic tape recording/reproducing device.

What is claimed is:

1. A method of adjusting a magnetic head position, wherein relative positions and inclination of a magnetic head gap which is provided in a slider surface of a magnetic head block and a pair of guide rollers which are disposed in an appropriate distance on both sides of the magnetic head block as a center are adjusted, comprising:
a step of adjusting relative positions and inclination of the magnetic head gap to a device reference plane which is defined on the magnetic tape recording/reproducing device; and
a step of adjusting relative positions and inclination of said pair of guide rollers to said device reference plane.

2. A method of adjusting a magnetic head position according to claim 1, wherein relative positions and inclination of the magnetic head gap to the device reference plane defined on the magnetic tape recording/reproducing device are adjusted with respect to six adjust elements which consist of position adjust elements along three axes each perpendicular to one another and inclination adjust elements in direction of rotation around axis, comprising:
a first step of adjusting with respect to the adjust elements in which a required adjust accuracy is low; and
a second step of adjusting with respect to the adjust elements in which a required adjust accuracy is high, after the first step of adjusting.

3. A magnetic head position adjusting device for adjusting relative positions and inclination of a magnetic head gap to a device reference plane defined on the magnetic tape recording/reproducing device, comprising:
a first reference plane defined on the adjust device;
a second reference plane fixed in a relative position previously defined;
a holding and fixing means for holding the magnetic recording/reproducing device which is disposed on the first reference plane and fixing the device reference plane of the magnetic tape recording/reproducing device; and
an optical microscope fixed on the second reference plane.

4. A method of adjusting a magnetic head position using the magnetic head position adjusting device according to claim 3 comprising:
a step of adjusting relative positions and inclination of the magnetic head gap to the device reference plane, which is defined on the magnetic tape recording/reproducing, on a basis of focus information of an entire field of image enlarged with the optical microscope.
